(19) United States
(12) Patent Application Publication
(10) Pub. No.: US 2026/0100860 A1
(43) Pub. Date: Apr. 9, 2026

(54) AUTOMATICALLY REGISTRABLE HOME APPLIANCE AND METHOD THEREFOR

(71) Applicant: LG ELECTRONICS INC., Seoul (KR)

(72) Inventors: Suhwan LEE, Seoul (KR); Hyunwoo JU, Seoul (KR)

(73) Assignee: LG ELECTRONICS INC., Seoul (KR)

(21) Appl. No.: 19/104,044

(22) PCT Filed: Aug. 31, 2022
(86) PCT No.: PCT/KR2022/012996

§ 371 Date: Feb. 14, 2025

(30) Foreign Application Priority Data
Aug. 30, 2022 (KR) 10-2022-0109070

(51) Int. Cl. H04L 12/28

(52) U.S. Cl. CPC H04L 12/2807; H04L 2012/285

(57) ABSTRACT

An embodiment provides a first home appliance comprising: a Wi-Fi module that receives medium access control (MAC) information of a second home appliance and broadcast information of the second home appliance from a server; and a control unit that determines whether the MAC information received via the Wi-Fi module matches with MAC information included in the broadcast information, and controls the Wi-Fi module, wherein the control unit requests the server to register the second home appliance on the basis that the MAC information received via the Wi-Fi module matches with the MAC information included in the broadcast information.

### TECHNICAL FIELD

The following description relates to a method and a device of automatically registering a newly purchased home appliance when it is delivered.

### BACKGROUND

Recently, with popularization of a mobile terminal such as a smartphone and development of an Internet of Things (IoT) technology, distribution of home appliances with a communication function is increasing.

The home appliance with the communication function may be connected to a server or the mobile terminal via an access point (AP) such as a router in a home. In addition, a user may conveniently check a state of the home appliance via the mobile terminal and remotely control an operation of the home appliance. Furthermore, the user may conveniently perform device registration for the home appliance via the mobile terminal.

In a related art (Korean Patent Application Publication No. 10-2014-0081270, published on Jul. 1, 2014), a mobile terminal capable of receiving remote control information and power information for the home appliance, a communication device, and an operation method thereof are disclosed. According to the above-mentioned prior art, it is disclosed that the mobile terminal may perform product registration for the home appliance by connecting to the communication device using network identifier information received from the communication device, receiving product information of the home appliance from the communication device, and then transmitting the product information to the server. However, with such existing product registration method, a suggested product for the registration may not belong to the user (e.g., a product belonging to a neighbor living in a next door), or the suggestion may not be made when the user is not at home (e.g., at work). In such cases, inefficiencies in the registration process may occur.

### SUMMARY

### Technical Problem

The embodiment(s) are intended to provide a method for automatically registering a home appliance newly purchased by a customer on a server after delivery and installation, and a home appliance that performs the same.

### Technical Solutions

According to an embodiment, provided is a first home appliance including a Wi-Fi module that receives medium access control (MAC) information of a second home appliance and broadcast information of the second home appliance from a server, and a controller that determines whether the MAC information received via the Wi-Fi module matches MAC information included in the broadcast information and controls the Wi-Fi module, wherein the controller requests registration of the second home appliance to the server based on a fact that the MAC information received via the Wi-Fi module matches the MAC information included in the broadcast information.

According to an embodiment, provided is a method for operating a first home appliance including receiving medium access control (MAC) information of a second home appliance and broadcast information of the second home appliance from a server, and determining whether the MAC information received via a Wi-Fi module matches MAC information included in the broadcast information, wherein registration of the second home appliance is requested to the server based on a fact that the MAC information received via the Wi-Fi module matches the MAC information included in the broadcast information.

The controller may instruct the second home appliance to connect to the server based on the fact that the MAC information received via the Wi-Fi module matches the MAC information included in the broadcast information.

The instruction may include router information.

The MAC information of the second home appliance may be transmitted based on a fact that a user of the first home appliance purchased the second home appliance.

The MAC information of the second home appliance may be transmitted based on start of delivery after purchase of the second home appliance.

The MAC information of the second home appliance may be transmitted based on a production information system, a delivery information system, and customer information related to the second home appliance.

The delivery information system may provide a serial number and the customer information of the second home appliance to the server.

The production information system may provide the serial number of the second home appliance and the MAC information of the second home appliance.

The first home appliance may be registered in the customer information.

The server may transmit the MAC information of the second home appliance corresponding to the serial number to the first home appliance registered in the customer information.

The request for the registration and instruction for connection may be performed independently of a user application related to the first home appliance.

### Advantageous Effects

According to an embodiment, the newly purchased home appliance may be registered immediately without running the app or manipulating the product. In other words, the product is registered simultaneously with the installation after the delivery, and the registration is performed without the product for the registration and the App manipulation, thereby maximizing the user convenience.

### BRIEF DESCRIPTION OF THE DRAWINGS

The drawings attached to the present document are intended to provide an understanding of the embodiment(s). Further, they are to illustrate various embodiments and to illustrate the principles together with the description of the present document.

FIG. 1 is a conceptual diagram illustrating a home appliance control system providing a home appliance control service according to an embodiment of the present disclosure.

FIG. 2 is a block diagram illustrating an unregistered home appliance in FIG. 1.

FIG. 3 is a block diagram illustrating a pre-registered home appliance in FIG. 1.

FIG. 4 is a block diagram illustrating a mobile terminal in FIG. 1.

FIG. 5 is a schematic diagram for illustrating an embodiment of the present disclosure.

FIGS. 6 to 7 are flowcharts according to an embodiment of the present disclosure.

FIG. 8 illustrates a WiFi module according to an embodiment.

### Best Mode

The above-mentioned purposes, features, and advantages will be described in detail below with reference to the attached drawings, so that a person having ordinary skill in the technical field to which the present disclosure belongs may easily realize the technical idea of the present disclosure. In describing the present disclosure, when it is determined that a specific description of the known technology related to the present disclosure may unnecessarily obscure the gist of the present disclosure, a detailed description will be omitted. Hereinafter, a preferred embodiment according to the present disclosure will be described in detail with reference to the attached drawings. In the drawings, the same reference numerals are used to indicate the same or similar components.

When it is described below that a certain component is “connected” or “coupled” to another component, it should be understood that the components may be directly connected or coupled to each other, but a third component may be “interposed” therebetween, or each component may be “connected” or “coupled” via the third component.

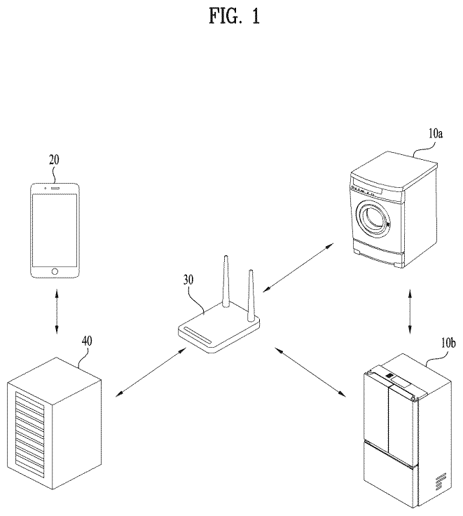

Hereinafter, a home appliance control system according to an embodiment of the present disclosure will be described with reference to FIG. 1.

FIG. 1 is a conceptual diagram illustrating a home appliance control system that provides a home appliance control service according to an embodiment of the present disclosure.

Referring to FIG. 1, the home appliance control system may correspond to a system that provides a service for remotely controlling a home appliance 10a and 10b in a home via a mobile terminal 20.

Such home appliance control system may include the at least one home appliance 10a and 10b, the mobile terminal 20, an access point (AP) 30, and a server 40.

The at least one home appliance 10a and 10b (inclusively 10) is an appliance that is installed in a space such as a home and performs various operations. In FIG. 1, a washing machine 10a and a refrigerator 10b are illustrated as an example of the at least one home appliance 10a and 10b, but types and the number of home appliances are not limited thereto.

For reference, one of the at least one home appliance 10a and 10b illustrated in FIG. 1 may be an unregistered home appliance 10a (i.e., a home appliance not registered on the server 40), and the other may be a registered home appliance 10b (i.e., a home appliance already registered on the server 40).

The mobile terminal 20 may include a terminal that a user may carry while moving, such as a smart phone, a tablet PC, a smart watch, a smart glass, and the like.

In one example, according to an embodiment, the home appliance control system may include a fixed terminal, such as a PC, as well as the mobile terminal.

An application for using the service provided by the home appliance control system according to an embodiment of the present disclosure may be installed on the mobile terminal 20. The user may remotely control an operation of the home appliance 10a and 10b in the home or remotely check a state of the home appliance 10a and 10b via the application installed on the mobile terminal 20.

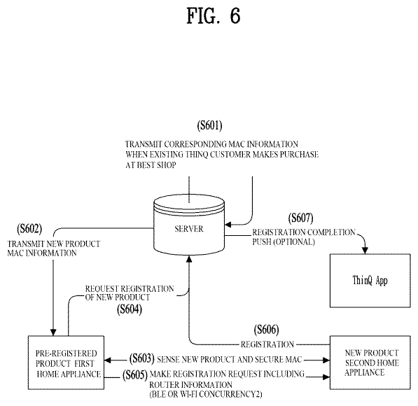

In one example, the user may register the home appliance 10a and 10b on the server 40 to use the service provided by the home appliance control system. In this regard, the user may register the home appliance 10a and 10b on the server 40 using the mobile terminal 20. This will be described later with reference to FIGS. 6 to 15.

The AP 30 may establish communication between the home appliance 10a and 10b and the server 40. For example, the home appliance 10a and 10b may include a Wi-Fi module that supports Wi-Fi wireless communication, and may be connected to the AP 30 via the Wi-Fi module.

Such AP 30 may correspond to a router that is generally equipped in the home. Hereinafter, to prevent confusion in terminology with an AP mode of a Wi-Fi module of the pre-registered home appliance (e.g., 10b) to be described later, the AP 30 is defined as a user AP 30.

The server 40, as a device that provides the home appliance control service, may be managed by a manufacturer or a service provider. The server 40 may store information on each user using the service. For example, the information on each user may include a user account, terminal information, user AP information, registered home appliance information, and the like.

When receiving a control command for a specific home appliance (e.g., the refrigerator 10b) from the mobile terminal 20, the server 40 may transmit the received control command to the refrigerator 10b via the user AP 30. In this regard, the refrigerator 10b may operate based on the received control command.

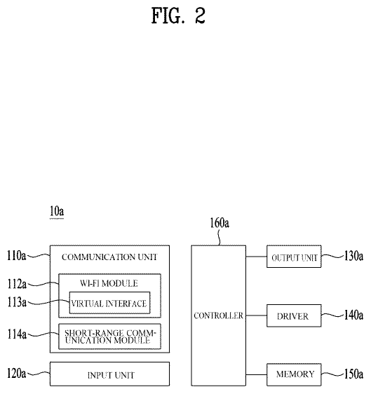

Hereinafter, with reference to FIGS. 2 to 4, control configurations of the home appliance 10a and 10b and the mobile terminal 20 according to an embodiment of the present disclosure will be briefly described.

FIG. 2 is a block diagram illustrating an unregistered home appliance in FIG. 1.

Referring to FIG. 2, the unregistered home appliance 10a may include a communication unit 110a, an input unit 120a, an output unit 130a, a driver 140a, a memory 150a, and a controller 160a. However, addition or omission of the components of the unregistered home appliance 10a illustrated in FIG. 2 may be achieved depending on a type of the unregistered home appliance 10a.

The communication unit 110a may include at least one communication module for connecting the unregistered home appliance 10a to the user AP 30, the pre-registered home appliance 10b, or the like. For example, the communication unit 110a may include a Wi-Fi module 112a supporting Wi-Fi wireless communication, and a short-range communication module 114a using Bluetooth or near field communication (NFC).

The Wi-Fi module 112a may operate in either the access point (AP) mode or a station mode under control of the controller 160a or a microcomputer within the Wi-Fi module 112a.

The AP mode may be a mode in which a connection is established between a peripheral apparatus (e.g., another peripheral home appliance or the like) and the unregistered home appliance 10a as the peripheral apparatus connects to the Wi-Fi module 112a. On the other hand, the station mode may be a mode in which a connection is established between the unregistered home appliance 10a and the user AP 30 as the Wi-Fi module 112a connects to the user AP 30.

The input unit 120a may include at least one input means for inputting a predetermined signal or data into the unregistered home appliance 10a by manipulation of the user. For example, the at least one input means may include a button, a dial, a touchpad, a microphone, and the like.

In one example, the input unit 120a may include an interface connected to a remote control device (not shown). That is, the input unit 120a may receive a control signal from the remote control device via the interface.

The output unit 130a may include an output means for informing the user of various information related to an operation of the unregistered home appliance 10a. For example, the output unit 130a may include a display or an optical output unit as a graphic or text output means, and may include a speaker or a buzzer as an audio output means.

The driver 140a, as a component that performs an operation related to a function provided by the unregistered home appliance 10a, may vary depending on a type of the unregistered home appliance 10a. For example, when the unregistered home appliance 10a is the washing machine, the driver 140a may include a drum motor, a water supply device, and the like.

In the memory 150a, various algorithms for the operation of the unregistered home appliance 10a, and various data such as control data for controlling the unregistered home appliance 10a, data for determining whether an error has occurred in the unregistered home appliance 10a, and a hidden SSID list may be stored.

The controller 160a may control the overall operation of the unregistered home appliance 10a. The controller 160a may control the driver 140a based on a control command, a function execution command, or the like input from the user. The controller 160a may include at least one CPU, a microcomputer, a processor, an integrated circuit, and the like.

In one example, to control the unregistered home appliance 10a via the service provided by the home appliance control system in FIG. 1, the user should register information on the unregistered home appliance 10a in the server 40.

To register the information on the unregistered home appliance 10a in the server 40, a communication connection between the unregistered home appliance 10a and the server 40 should be established. To this end, the Wi-Fi module 112a of the unregistered home appliance 10a may connect to the user AP 30, thereby being connected to the server 40 via the user AP 30.

For the unregistered home appliance 10a to connect to the user AP 30, it should obtain information on the user AP 30. In general, the user provides the information on the user AP 30 to the unregistered home appliance 10a via the mobile terminal 20, but in the embodiment of the present disclosure, the unregistered home appliance 10a may receive the information on the user AP 30 from the pre-registered home appliance 10b.

In one example, according to an embodiment of the present disclosure, the Wi-Fi module 112a of the unregistered home appliance 10a may be implemented to have a virtual interface 113a. Accordingly, the unregistered home appliance 10a may be connected to two devices simultaneously via the Wi-Fi module 112a having the virtual interface 113a.

For reference, the virtual interface 113a is a virtual interface added by time-sharing one physical Wi-Fi interface. Therefore, the Wi-Fi module 112a may perform a communication function as if two physical Wi-Fi interfaces are operating using such virtual interface 113a.

Accordingly, the unregistered home appliance 10a may be connected to the pre-registered home appliance 10b, obtain the information on the user AP 30, and attempt to connect to the user AP 30 while maintaining the connection with the pre-registered home appliance 10b.

In this regard, the information on the user AP 30 may include a service set identifier (SSID) and a password of the user AP 30.

In one example, the unregistered home appliance 10a may not use the virtual interface 113a when attempting to connect to the user AP 30. That is, the unregistered home appliance 10a may be connected to the pre-registered home appliance 10b to obtain the information on the user AP 30, terminate the connection with the pre-registered home appliance 10b, and then attempt to connect to the user AP 30.

For reference, when establishing the connection (i.e., the communication connection) between the unregistered home appliance 10a and the pre-registered home appliance 10b, authentication may be performed via a certificate-based server for security. That is, the communication between the unregistered home appliance 10a and the pre-registered home appliance 10b may be performed via a secure channel (e.g., a communication channel used by the pre-registered home appliance 10b).

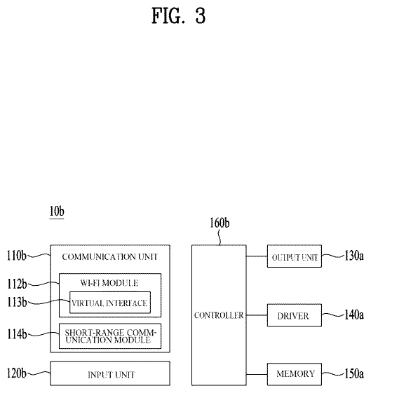

FIG. 3 is a block diagram illustrating a pre-registered home appliance in FIG. 1.

Referring to FIG. 3, the pre-registered home appliance 10b may include a communication unit 110b, an input unit 120b, an output unit 130b, a driver 140b, a memory 150b, and a controller 160b. However, addition or omission of the components of the pre-registered home appliance 10b illustrated in FIG. 3 may be achieved depending on a type of the pre-registered home appliance 10b.

The communication unit 110b may include at least one communication module for connecting the pre-registered home appliance 10b to the server 40 or the unregistered home appliance 10a. For example, the communication unit 110b may include a Wi-Fi module 112b supporting Wi-Fi wireless communication, and a short-range communication module 114b using Bluetooth or near field communication (NFC).

The Wi-Fi module 112b may operate in either the access point (AP) mode or the station mode under control of the controller 160b or a microcomputer in the Wi-Fi module 112b.

The AP mode may be a mode in which a connection is established between a peripheral apparatus (e.g., another peripheral home appliance or the like) and the pre-registered home appliance 10b as the peripheral apparatus connects to the Wi-Fi module 112b. On the other hand, the station mode may be a mode in which a connection is established between the pre-registered home appliance 10b and the user AP 30 as the Wi-Fi module 112b connects to the user AP 30.

The input unit 120b may include at least one input means for inputting a predetermined signal or data into the pre-registered home appliance 10b by manipulation of the user. For example, the at least one input means may include a button, a dial, a touchpad, a microphone, and the like.

In one example, the input unit 120b may include an interface connected to a remote control device (not shown). That is, the input unit 120b may receive a control signal from the remote control device via the interface.

The output unit 130b may include an output means for informing the user of various information related to an operation of the pre-registered home appliance 10b. For example, the output unit 130b may include a display or an optical output unit as a graphic or text output means, and may include a speaker or a buzzer as an audio output means.

The driver 140b, as a component that performs an operation related to a function provided by the pre-registered home appliance 10b, may vary depending on a type of the pre-registered home appliance 10b. For example, when the pre-registered home appliance 10b is the refrigerator, the driver 140b may include a compressor, an evaporator, a defrost heater, and the like.

In the memory 150a, various algorithms for the operation of the pre-registered home appliance 10b, and various data such as control data for controlling the pre-registered home appliance 10b, data for determining whether an error has occurred in the pre-registered home appliance 10b, and a hidden SSID list may be stored.

The controller 160b may control the overall operation of the pre-registered home appliance 10b. The controller 160b may control the driver 140b based on a control command, a function execution command, or the like input from the user. The controller 160b may include at least one CPU, a microcomputer, a processor, an integrated circuit, and the like.

The pre-registered home appliance 10b is already registered in the server 40 and connected to the user AP 30, so that the user may control the pre-registered home appliance 10b via the service provided by the home appliance control system in FIG. 1.

In addition, according to an embodiment of the present disclosure, the Wi-Fi module 112b of the pre-registered home appliance 10b may be implemented to have a virtual interface 113b. Accordingly, the pre-registered home appliance 10b may be connected to two devices simultaneously via the Wi-Fi module 112b having the virtual interface 113b.

For reference, the virtual interface 113b is a virtual interface added by time-sharing one physical Wi-Fi interface. Therefore, the Wi-Fi module 112b may perform a communication function as if two physical Wi-Fi interfaces are operating using such virtual interface 113b.

Accordingly, the pre-registered home appliance 10b may be connected to the user AP 30 via the Wi-Fi module 112b, obtain the information on the user AP 30, and periodically operate in the AP mode via the virtual interface 113b. In addition, when operating in the AP mode, the Wi-Fi module 112b may generate a beacon signal and may use a hidden SSID to search for unregistered home appliances in the vicinity.

In addition, when receiving a connection request from the unregistered home appliance 10a that has recognized the hidden SSID via the virtual interface 113b, the Wi-Fi module 112b may be connected to the unregistered home appliance 10a that has recognized the hidden SSID under the control of the controller 160b.

In addition, the Wi-Fi module 112b may receive a push signal from the connected unregistered home appliance 10a, and may provide the information on the user AP 30 to the connected unregistered home appliance 10a.

In other words, the pre-registered home appliance 10b may also be connected to the unregistered home appliance 10a via the virtual interface 113b while maintaining the connection with the user AP 30.

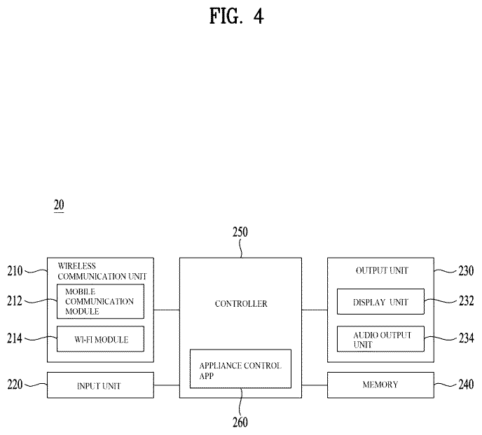

FIG. 4 is a block diagram illustrating a mobile terminal in FIG. 1.

Referring to FIG. 4, the mobile terminal 20 may include a wireless communication unit 210, an input unit 220, an output unit 230, a memory 240, and a controller 250. The components illustrated in FIG. 4 are not essential for implementing the mobile terminal 20, so that the mobile terminal 20 may include more or fewer components.

The wireless communication unit 210 may include at least one communication module for connecting the mobile terminal 20 to the server 40 or the like. For example, the wireless communication unit 210 may include a mobile communication module 212 using long term evolution (LTE) or the like, a Wi-Fi module 214, and other short-range communication module or a wireless Internet module.

The input unit 220 may include a camera or a video input unit for inputting a video signal, a microphone or an audio input unit for inputting an audio signal, and a user input unit (e.g., a touch key, a mechanical key, and the like) for receiving information from the user.

The output unit 230, which is for generating an output related to vision, hearing, or touch, may include, for example, a display 232 and an audio output unit 234.

In one example, the display 232 may constitute a layered structure with a touch sensor and or formed integrally with the touch sensor, thereby implementing a touch screen. Such touch screen may function as the user input unit (i.e., capable of receiving a touch input from the user) that provides an input interface between the mobile terminal 20 and the user, and simultaneously, may provide an output interface between the mobile terminal 20 and the user.

For reference, an image displayed on the display 232 may be controlled by the controller 250, and the display 232 may provide the touch input received from the user to the controller 250.

The memory 240 may store data supporting various functions of the mobile terminal 20. The memory 240 may store multiple applications running on the mobile terminal 20, data for an operation of the mobile terminal 20, commands, and a hidden SSID list. At least some of such applications may be downloaded from an external server via wireless communication.

The controller 250 may control the overall operation of the mobile terminal 20.

The controller 250 may process signals, data, information, and the like input or output via the above-described components, or may provide or process information or functions appropriate for the user by running the application stored in the memory 240.

In particular, the controller 250 of the mobile terminal 20 according to an embodiment of the present disclosure may run an appliance control application (APP) 260 that may control the home appliance registered on the service provided by the home appliance control system (i.e., the pre-registered home appliance 10b).

The appliance control APP 260 may be downloaded from the server 40 or a server providing an application download service and stored in the memory 240.

The user may perform various management such as controlling the pre-registered home appliance 10b, registering the unregistered home appliance 10a on the service, or removing the pre-registered home appliance 10b from the service, via the appliance control APP 260.

For reference, when the appliance control APP 260 is executed, the pre-registered home appliances may be automatically searched (e.g., searched via the generation of the beacon signal) or the pre-registered home appliances may be searched by manual manipulation of the user.

Specifically, all pre-registered home appliances operating in the AP mode and all pre-registered home appliances connected to the same user AP 30 as the mobile terminal 20 may be searched using a hidden SSID (i.e., a hidden SSID that matches the hidden SSID list stored in the memory 240 of the mobile terminal 20). Further, all of the pre-registered home appliances searched by the mobile terminal 20 may provide push signals to the mobile terminal 20.

In this case, the controller 250 of the mobile terminal 20 may control the display 232 to display a selection screen for connection with the pre-registered home appliances in response to the push signals of the pre-registered home appliances, and may receive a selection input for the connection with the pre-registered home appliances from the user via the input unit 220 or the display 232. In addition, the controller 250 may control the display 232 to display a registration confirmation key input guide screen for the pre-registered home appliance based on the received connection selection input. Further, when a registration confirmation key input for the pre-registered home appliance is completed by the user, the corresponding pre-registered home appliance may be controlled via the appliance control APP 260.

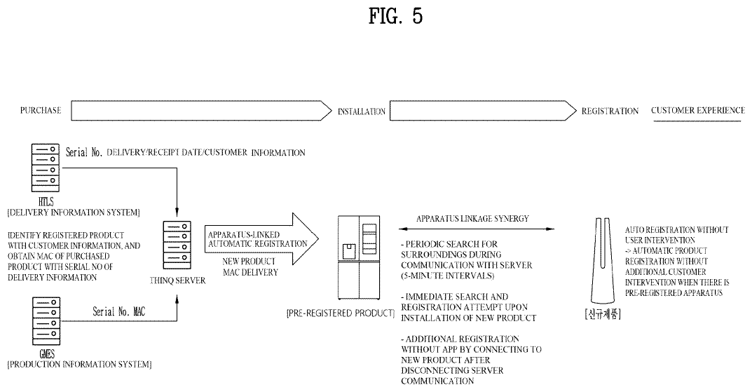

As such, the home appliance control system according to an embodiment of the present disclosure has the aforementioned configuration and features. Therefore, hereinafter, with reference to FIGS. 5 to 15, an embodiment related to an operation of registering the unregistered home appliance 10a on the home appliance control service provided by the home appliance control system will be described. In addition, the description will be made with reference to FIGS. 1 to 4 together.

Hereinafter, based on the above description, a method for automatically registering a home appliance according to an embodiment of the present disclosure will be described. In the following description, a first home appliance corresponds to a pre-registered product that a specific customer/user has previously purchased and possesses, and a second home appliance corresponds to a new product that the specific customer/user newly purchased (at a store), delivered, and installed.

The first home appliance according to an embodiment may include a Wi-Fi module that receives medium access control (MAC) information of the second home appliance and broadcast information of the second home appliance from a server; and a controller that determines whether the MAC information received via the Wi-Fi module matches MAC information included in the broadcast information and controls the Wi-Fi module.

The controller may request the server to register the second home appliance based on whether the MAC information received via the Wi-Fi module matches the MAC information included in the broadcast information. In addition, the controller may instruct the second home appliance to connect to the server based on the MAC information received via the Wi-Fi module matching the MAC information included in the broadcast information, and the instruction may include router information.

The MAC information of the second home appliance may be transmitted based on the fact that the user of the first home appliance has purchased the second home appliance. Alternatively, the MAC information of the second home appliance may be transmitted based on start of the delivery after the purchase of the second home appliance.

In this regard, referring to FIG. 5, the MAC information of the second home appliance may be transmitted based on a production information system, a delivery information system, and customer information related to the second home appliance. The delivery information system may provide a serial number and the customer information of the second home appliance to the server. The production information system may provide the serial number of the second home appliance and the MAC information of the second home appliance. The first home appliance may be registered in the customer information. Accordingly, the server may transmit the MAC information of the second home appliance corresponding to the serial number to the first home appliance registered in the customer information.

In summary, the delivery information system and the production information system are used to inform the user's pre-registered product of purchase information. Accordingly, the server may identify the registered product with the customer information, and obtain the MAC of the purchased product with the Serial No of the delivery information. In other words, the corresponding MAC is transmitted to the pre-registered product and used as a factor that may identify the product I purchased. In addition, in the registration after the delivery, as a method of recognizing the purchased product using product-to-product communication, the new product broadcasts its presence at a specific time point, and the existing user product periodically scans surroundings when receiving the MAC of the purchased product as described above to check whether the product purchased by the user is broadcasting.

According to the above-described embodiment, automatic registration using the product-to-product communication may be performed. Specifically, all scenarios of executing an existing ThinQ App, pressing registration, selecting a product from a category, manipulating the product based on a guide, and entering network information are omitted. Further, at a moment the existing user product recognizes the purchased product, the network information it knows is shared via the mutual communication and the purchased product is automatically registered on the server without the App. In other words, the registration request and the connection instruction are performed regardless of the user application related to the first home appliance.

FIG. 6 illustrates a product registration procedure/method according to the above-described embodiment. Referring to FIG. 6, the server may receive the MAC information based on the fact that the user of the first home appliance has purchased the second home appliance (S601). For details related thereto, refer to the above description.

In step S602, the first home appliance may receive the medium access control (MAC) information of the second home appliance and the broadcast information of the second home appliance from the server.

The first home appliance may determine whether the MAC information received via the Wi-Fi module matches the MAC information included in the broadcast information, and then request the server to register the second home appliance based on the fact that the MAC information received via the Wi-Fi module matches the MAC information included in the broadcast information (S604). In addition, the controller may instruct the second home appliance to connect to the server based on the fact that the MAC information received via the Wi-Fi module matches the MAC information included in the broadcast information, and the instruction may include the router information (S605).

That is, the Wi-Fi module mounted on the product receives the MAC of the new product purchased by the user at the Best shop from the server based on the scenario, as shown in FIG. 6 and periodically performs sensing. When identifying the information broadcasted by the product of the corresponding MAC, the Wi-Fi module transmits the connection instruction including the router information, and registers the new product on the server on behalf of the App.

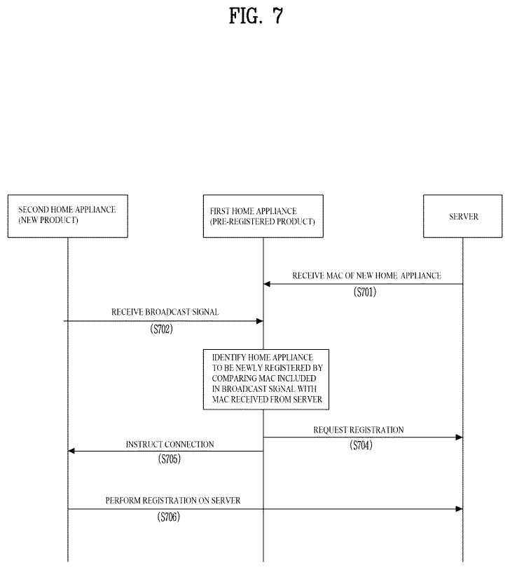

FIG. 7 illustrates a flowchart of the above-described embodiment.

Referring to FIG. 7, the first home appliance receives the medium access control (MAC) information of the second home appliance from the server (S701).

When the second home appliance is installed, the broadcast information of the second home appliance may be received (S702).

By determining whether the MAC information received via the Wi-Fi module matches the MAC information included in the broadcast information, the home appliance to be newly registered may be identified (S703).

Based on the fact that the MAC information received via the Wi-Fi module matches the MAC information included in the broadcast information, the server may be requested to register the second home appliance (S704). In addition, the controller may instruct the second home appliance to connect to the server based on the fact that the MAC information received via the Wi-Fi module matches the MAC information included in the broadcast information, and the instruction may include the router information (S705).

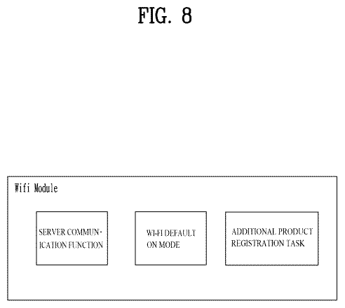

FIG. 8 illustrates an example of a WiFi module according to an embodiment of the present disclosure.

The WiFi module has a server communication function, a Wi-Fi Default On mode, and an additional product registration task.

The server communication function is a communication function of receiving new product information from a ThinQ server, and a detailed description is replaced with the above description. The Wi-Fi Default On mode means that the new product performs the broadcasting and operates in the AP mode so as to be in communication with the existing product when it is turned on.

The additional product registration task is a task of registering the product on the ThinQ server on behalf of the App when the purchased new product information matches the product sensed in the surroundings, and means the automatic registration method of the second home appliance according to the above-described embodiment.

The home appliance may be a home appliance including a WiFi BLE device. For example, the home appliance may be one of home appliances such as a shoe styler, a washing machine, a refrigerator, and the like.

### INDUSTRIAL APPLICABILITY

The embodiments described above may be applied to various mobile communication systems.

What is claimed is:

1. A first home appliance comprising:
a Wi-Fi module configured to receive medium access control (MAC) information of a second home appliance and broadcast information of the second home appliance from a server;
and a controller configured to determine whether the MAC information received via the Wi-Fi module matches MAC information included in the broadcast information and control the Wi-Fi module, wherein the controller is configured to request registration of the second home appliance to the server based on a fact that the MAC information received via the Wi-Fi module matches the MAC information included in the broadcast information.

2. The first home appliance of claim 1, wherein the controller is configured to instruct the second home appliance to connect to the server based on the fact that the MAC information received via the Wi-Fi module matches the MAC information included in the broadcast information.

3. The first home appliance of claim 2, wherein the instruction includes router information.

4. The first home appliance of claim 1, wherein the MAC information of the second home appliance is transmitted based on a fact that a user of the first home appliance purchased the second home appliance.

5. The first home appliance of claim 1, wherein the MAC information of the second home appliance is transmitted based on start of delivery after purchase of the second home appliance.

6. The first home appliance of claim 5, wherein the MAC information of the second home appliance is transmitted based on a production information system, a delivery information system, and customer information related to the second home appliance.

7. The first home appliance of claim 6, wherein the delivery information system provides a serial number and the customer information of the second home appliance to the server.

8. The first home appliance of claim 7, wherein the production information system provides the serial number of the second home appliance and the MAC information of the second home appliance.

9. The first home appliance of claim 8, wherein the first home appliance is registered in the customer information.

10. The first home appliance of claim 9, wherein the server transmits the MAC information of the second home appliance corresponding to the serial number to the first home appliance registered in the customer information.

11. The first home appliance of claim 1, wherein the request for the registration and instruction for connection are performed independently of a user application related to the first home appliance.

12. A method for operating a first home appliance, the method comprising:
receiving medium access control (MAC) information of a second home appliance and broadcast information of the second home appliance from a server; and
determining whether the MAC information received via a Wi-Fi module matches MAC information included in the broadcast information,
wherein registration of the second home appliance is requested to the server based on a fact that the MAC information received via the Wi-Fi module matches the MAC information included in the broadcast information.
